(19) United States
(12) Patent Application Publication
(10) Pub. No.: US 2003/0071457 A1
(43) Pub. Date: Apr. 17, 2003

(54) Fluid control apparatus and its manufacturing method

(75) Inventor: Hiroshi Imai, Saitama (JP)

Correspondence Address: BROWDY AND NEIMARK, P.L.L.C., 624 NINTH STREET, NW, SUITE 300, WASHINGTON, DC, 20001-5303, US

(73) Assignee: SURPASS INDUSTRY CO. LTD., Gyoda-shi (JP)

(21) Appl. No.: 10/235,805

(22) Filed: Sep. 6, 2002

(30) Foreign Application Priority Data
Sep. 6, 2001 (JP) 2001-269740

(51) Int. Cl. F16L 13/02

(52) U.S. Cl. 285/21.1; 285/288.1

(57) ABSTRACT

A fluid control apparatus and its manufacturing method can meet various demands or needs on specification of a customer. This saves a maker of the apparatus a large stock of various types of the apparatus and the use of an expensive mold. Consequently, the apparatus and its manufacturing method are advantageous from an economical point of view. The apparatus is provided with a pair of plastic coupling openings (2) and (3) in its inlet and its outlet portion, respectively. The coupling openings (2) and (3) form a pair of opposite end projections of the apparatus, and are capable of being welded to plastic tube members (4) and (5) of a customer's designed fluid circuit, respectively, through a butt welding process when the apparatus is delivered to the customer. The tube members (4) and (5) are designed according to the customer's design specification.

### BACKGROUND OF THE INVENTION

1. Field of the Invention

The present invention relates to a fluid control apparatus and its manufacturing method of producing the apparatus. More particularly, the present invention relates to the fluid control apparatus and its manufacturing method, wherein: any one of flow meters, pressure gauges, air-operated valves, regulators and like fluid instruments disposed in a fluid circuit for treating an appropriate liquid such as a chemical solution, a fluid chemical agent and like liquids is provided with both a fluid inlet and a fluid outlet portion; and, each of the fluid inlet and the fluid outlet portion of the fluid control apparatus has a tube-like form extending outward from each of the fluid inlet and the fluid outlet portion of the fluid control apparatus.

2. Description of the Related Art

For example, as for a semiconductor fabrication apparatus, in laying out in fluid circuit its plumbing components such as tube members and a fluid control apparatus such as flow meters, pressure gauges, air-operated valves and like fluid control apparatus or instruments, a customer such as a semiconductor producer or a device maker often requires a specific tube-connecting system. Due to this, for example, as shown in FIGS. 3, 4(A), 4(B), 4(C) and 4(D), it is necessary for a maker or supplier of the plumbing components to have both its tube members 12, 13 and its fluid control apparatus arranged to meet a specific coupler 14 required by the customer such as the semiconductor producer or device maker.

Consequently, even when there is substantially no difference in performance between the fluid control apparatuses required by the individual customers (i.e., semiconductor producers or device makers), it is necessary for the maker or supplier of the plumbing components to produce and provide a fluid control apparatus of a specific type to each of the individual semiconductor producers or device makers since each of the individual semiconductor producers or device makers requires its own specific tube-connecting system. This forces the maker or supplier of the plumbing components to produce and stock a large amount of various types of fluid control apparatuses which may meet various types of the tube-connecting systems required by the individual semiconductor producers or device makers. Such a large amount of the various-type fluid control apparatuses thus produced and stocked in the maker of the plumbing components increases the manufacturing cost of the fluid control apparatus.

In each of the various-type fluid control apparatuses described above, its fluid inlet portion, its fluid outlet portion and its main body portion are integrally formed into an integral entity by a molding process or a machining process.

Although the molding process is excellent in manufacturing efficiency, the molding process is much more expensive in cost than the machining process since a mold used in the molding process is very expensive. Due to this cost problem, it is difficult to provide various types of the mold varying in shape and length of the tube portion of the fluid control apparatus or instrument, which makes it substantially impossible to meet various modifications in shape and length of the tube portion of the fluid control apparatus required by the customer (i.e., semiconductor producer or device maker). Even when a mold is produced, it is necessary for such a mold to have a considerable length in order to provide a sufficient-length tube portion of the fluid control apparatus. On the other hand, as for the machining process, the machining process often impairs its product such as the fluid control apparatus in physical strength due to its cutting-off operation applied to the product, which makes it substantially impossible to meet various modifications in shape and length of the tube portion of the fluid control apparatus required by the semiconductor producer or device maker. Further, the machining process is poor in saving the material of the product due to its cutting-off operation of the material, which results in an increase in manufacturing cost of the fluid control apparatus.

The problems to be solved by the present invention is as follows: namely, as described above, in the conventional fluid control apparatus or instrument, in order to deliver without any delay a product provided with a specific tube-connecting system which meets the various demands and needs of the customer, it is necessary for the maker or supplier of the fluid control apparatus to produce and stock a large amount of various types of the fluid control apparatuses. However, the needs for individual types of the fluid control apparatuses thus stocked are relatively small and vary in type and in amount in a random manner. Due to this, most of the inventory of the conventional fluid control apparatuses are not used, and therefore go to waste. Naturally, in order to reduce the inventory of the conventional fluid control apparatuses, it is possible for the supplier to produce the conventional fluid control apparatuses after receiving an order for the apparatuses from the customer. In this case, however, it is not possible for the supplier to fill the order immediately. This is a main drawback of the conventional fluid control apparatus in this case.

### SUMMARY OF THE INVENTION

Consequently, it is a primary object of the present invention to provide a fluid control apparatus, which is capable of meeting various demands and needs of a customer on specifications of the apparatus and therefore capable of saving the need of a large stock of various types of the fluid control apparatus.

It is a secondary object of the present invention to provide a method of manufacturing a fluid control apparatus provided with an inlet and an outlet portion each of which has a flexible general-purpose tube member extending outward from a main body of the fluid control apparatus, wherein the fluid control apparatus is free from any problem inherent in a conventional type of fluid control apparatus, for example such as an essential lack of flexibility in coupling in the conventional fluid control apparatus in which its main body and its tube members are integrally formed through a molding process by using an expensive mold.

The above primary object of the present invention is accomplished by providing:

In a fluid control apparatus comprising an inlet portion, an outlet portion, and a main body portion (1); the improvement wherein: the inlet portion and the outlet portion are provided with an inlet coupling opening (2) and an outlet coupling opening (3), respectively, wherein each of the inlet coupling opening (2) and the outlet coupling opening (3) is made of a plastic material capable of being welded to a plastic material of its own type or to plastic materials of other types and extends outward from the main body portion (1); and, each of the coupling openings (2, 3) is welded to each of plastic tube members (4, 6) of a fluid circuit of a customer through a butt welding process when the fluid control apparatus is delivered to the customer, wherein the fluid circuit is formed according to a design required by the customer.

Further, the above secondary object of the present invention is accomplished by providing:

A method of manufacturing a fluid control apparatus, comprising the step of:

carrying out a butt welding process between: each of an inlet coupling opening (2) and an outlet coupling opening (3) both of which extend outward from a main body portion (1) of the fluid control apparatus, wherein each of the inlet coupling opening (2), the outlet coupling opening (3) and the main body portion (1) is made of a first plastic material; and, a predetermined tube member which is disposed adjacent to each of the inlet coupling opening (2) and the outlet coupling opening (3) and made of a second plastic material capable of being welded to the first plastic material.

### BRIEF DESCRIPTION OF THE DRAWINGS

The above and other objects, advantages and features of the present invention will be more apparent from the following description taken in conjunction with the accompanying drawings in which:

FIG. 1 is a side elevation view of an embodiment of the fluid control apparatus of the present invention;

FIG. 2 is a partially broken side view of the embodiment of the present invention shown in FIG. 1, illustrating a welded portion formed between the coupling opening of the fluid control apparatus and the tube member;

FIG. 3 is a side elevation view of a conventional fluid control apparatus, illustrating its plumbing portions; and

FIGS. 4A, 4B, 4C and 4D are sectional views of various types of the conventional fluid control apparatuses, illustrating various types of coupling units used therein.

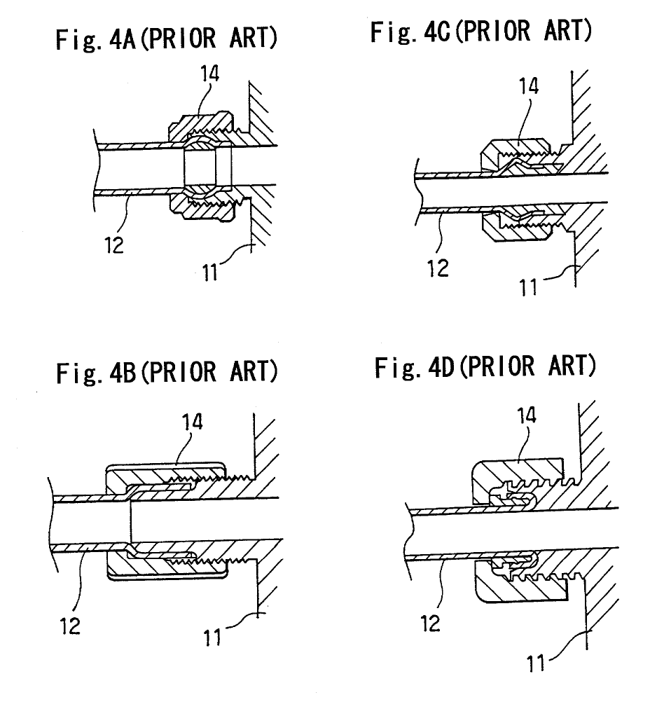

### DETAILED DESCRIPTION OF THE PREFERRED EMBODIMENTS

The best modes for carrying out the present invention will be described in detail using embodiments of the present invention with reference to the accompanying drawings.

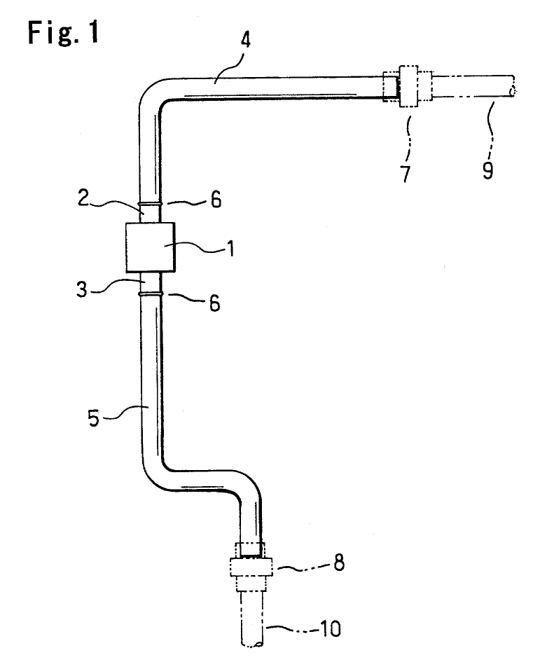

As shown in FIG. 1, a fluid control apparatus of an embodiment of the present invention is provided with a main body portion 1. This main body portion 1 is provided with an inlet coupling opening 2 and an outlet coupling opening 3 in an inlet and an outlet portion of the main body portion 1, respectively. Each of the inlet coupling opening 2 and the outlet coupling opening 3 is integrally formed with the main body portion 1 of the fluid control apparatus to extend a distance of, for example, approximately 2 cm outward from the main body portion 1. Each of the main body portion 1 and the coupling openings 2, 3 is made of a first plastic material, for example such as fluorine plastics and like plastic materials which is capable of being welded to a plastic material of its own type or plastic materials of other types, and leaves its opening end portion simply cut off without applying any special treatment to the thus cut-off opening end portion.

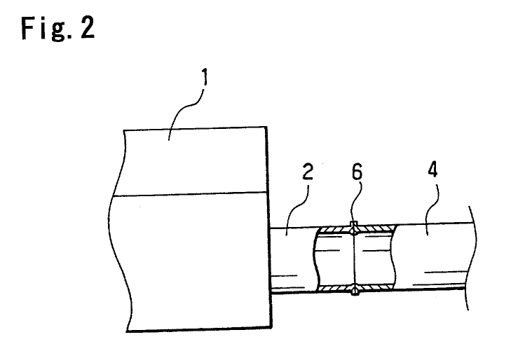

The plastic coupling openings 2 and 3 of the main body portion 1 are welded to plastic tube members 4 and 5 of plumbing components in the fluid circuit, respectively, through a butt welding process when the fluid control apparatus is delivered to a customer (see, a welded portion 6 shown in FIG. 2), so that the plastic tube members 4 and 5 form extensions of the plastic coupling openings 2 and 3, respectively. Incidentally, these tube members 4, 5 are previously selected according to the design specification of the fluid circuit supplied from the customer. The fluid control apparatus of the present invention is delivered to the customer. More specifically, each of the tube members 4, 5 is made of a second plastic material designed or specified according to the customer's design specification. The second plastic material is capable of being welded to the first plastic material of each of the coupling openings 2, 3 of the fluid control apparatus of the present invention through the butt welding process. This butt welding process of the tube members 4, 5 is performed using a plastic welder provided with an appropriate heat source, for example such as a far infrared heater and the like. Further, in the case of the fluid control apparatus of the present invention, even when there is no stock of the tube members 4, 5 required by the customer, it suffices for the maker or supplier of the fluid control apparatus to simply produce these required tube members 4, 5 only.

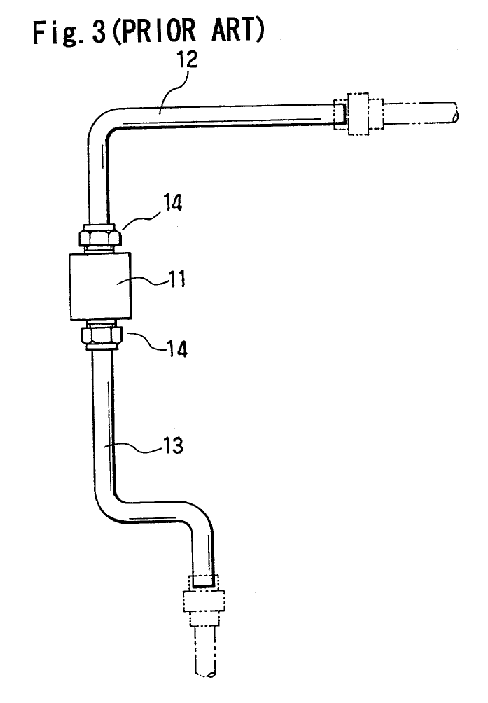

As described above, the fluid control apparatus of the present invention thus produced is delivered to the customer in a condition in which the tube members 4 and 5 have been already welded to the plastic coupling openings 2 and 3 of the main body portion 1 of the fluid control apparatus, respectively. Consequently, it is possible for the customer to eliminate a cumbersome tube-connecting work required to connect the coupling openings 2, 3 of the fluid control apparatus with the plumbing components of the customer's own fluid circuit, by simply connecting a pair of tube members 9 and 10 of the customer's own fluid circuit with the tube members 4 and 5 of the fluid control apparatus of the present invention, respectively, through the welded portions, one 6 of which welded portions is shown in FIG. 2. This makes it possible to eliminate the necessity of a conventional coupler 14 which is employed in the conventional fluid control apparatus, as shown in FIG. 3.

Now, the effect of the present invention will be described. Since the fluid control apparatus of the invention has the construction described above, in the fluid control apparatus and its manufacturing method according to the present invention, it is not required to connect the coupling openings of the apparatus with any coupler such as the conventional coupler 14 shown in FIG. 13. In other words, the fluid control apparatus of the present invention is capable of meeting various demands and needs of the customer by using its flexible general-purpose tube members 4, 5 since these tube members 4, 5 are capable of being welded to the tube members 9,10 of the customer's own designed fluid circuit. This makes it possible to eliminate the use of the expensive mold, and therefore results in a considerable cost reduction in manufacturing the fluid control apparatus of the present invention. Further, in the present invention, since there is no need for a large stock of various types of the fluid control apparatus, the present invention is advantageous in saving both the cost and the space required in inventory control of such various types of the fluid control apparatus.

Furthermore, in the present invention, the conventional coupler such as one 14 shown in FIG. 3 is not required at all in each of the coupling openings 2, 3 of the fluid control apparatus of the present invention, the manufacturing cost of the fluid control apparatus of the present invention is further reduced. Still further, in the fluid control apparatus of the present invention, there is no fear of a leakage problem resulted from the presence of such conventional coupler 14. Further, the customer is released from a cumbersome plumbing work of tube members required in coupling his or her fluid circuit with the conventional fluid control apparatus. This makes it possible for the customer to considerably reduce the installation cost and time of the fluid control apparatus of the present invention.

Finally, the present application claims the Convention Priority based on Japanese Patent Application No. 2001-269740 filed on Sep. 6, 2001, which is herein incorporated by reference.

What is claimed is:

1. In a fluid control apparatus comprising an inlet portion, an outlet portion, and a main body portion (1); the improvement wherein: said inlet portion and said outlet portion are provided with an inlet coupling opening (2) and an outlet coupling opening (3), respectively, wherein each of said inlet coupling opening (2) and said outlet coupling opening (3) is made of a plastic material capable of being welded to a plastic material of its own type or to plastic materials of other types and extends outward from said main body portion (1); and, each of said coupling openings (2, 3) is welded to each of plastic tube members (4, 6) of a fluid circuit of a customer through a butt welding process when said fluid control apparatus is delivered to said customer, wherein said fluid circuit is formed according to a design required by said customer.

2. A method of manufacturing a fluid control apparatus, comprising the step of:
carrying out a butt welding process between: each of an inlet coupling opening (2) and an outlet coupling opening (3) both of which extend outward from a main body portion (1) of said fluid control apparatus, wherein each of said inlet coupling opening (2), said outlet coupling opening (3) and said main body portion (1) is made of a first plastic material; and, a predetermined tube member which is disposed adjacent to each of said inlet coupling opening (2) and said outlet coupling opening (3) and made of a second plastic material capable of being welded to said first plastic material.
